(19) United States
(12) Patent Application Publication
(10) Pub. No.: US 2014/0376029 A1
(43) Pub. Date: Dec. 25, 2014

(54) IMAGE PROCESSING APPARATUS, IMAGE PROCESSING APPARATUS CONTROL METHOD, AND RECORDING MEDIUM

(71) Applicant: CANON KABUSHIKI KAISHA, Tokyo (JP)

(72) Inventor: Naotsugu Itoh, Kawasaki-shi (JP)

(21) Appl. No.: 14/308,515

(22) Filed: Jun. 18, 2014

(30) Foreign Application Priority Data
Jun. 21, 2013 (JP) 2013-130197

(51) Int. Cl. G06F 3/12

(52) U.S. Cl. CPC G06F 3/1257; G06F 3/1203
USPC 358/1.14

(57) ABSTRACT

In an image processing apparatus that is in a logged-on state, if a user detection sensor unit changes from a detecting to a non-detecting state, the image processing apparatus retains its current state while displaying a re-authentication screen. The re-authentication screen prohibits operations other than authentication while requesting user authentication. If a currently logged-on user is authenticated, the image processing apparatus returns to its retained state.

### BACKGROUND

1. Field

Aspects of the present invention generally relate to control of an image processing apparatus that performs user authentication.

2. Description of the Related Art

Some image processing apparatuses are capable of specifying a user by performing logon based on user authentication to determine whether to allow access to data that only predetermined users can access, or to record a usage state and charging information about an apparatus in each group that a user belongs to.

Japanese Patent Application Laid-Open No. 2008-168588 discusses a technology in which a user logs off from a logged-on state by pressing a logoff button, and also automatically logs off if a predetermined duration has elapsed since the user moved away from the apparatus.

Japanese Patent Application Laid-Open No. 2010-23451 discusses a technology which, if a user logs off while in the midst of an operation, saves the operation content so that the operation content can be restored the next time the user logs on.

In user management that is based on the above-described logging on, if a user A moves away from an apparatus while the user A is still logged on, another user B can use the apparatus without logging on by pretending to be the user A.

To avoid the above, according to the technology discussed in Japanese Patent Application Laid-Open No. 2008-168588, use of the apparatus by the other user B, who is pretending to be the user A without the user A knowing, is prevented by shortening this predetermined duration so that the user A is logged off immediately after moving away from the apparatus. However, in this method, since the settings are returned to their initial states when the user logs on again after logging off, if the user A moves away from the apparatus in the midst of an operation, the user A has to re-perform the operation from the beginning after logging on again, which causes user convenience to deteriorate.

To avoid this, the work and effort by the user to reset the settings can be reduced by utilizing the technology discussed in Japanese Patent Application Laid-Open No. 2010-23451. However, in this method, during logon, since some settings are returned to their initial state and some settings are restored to the state of the stored operation content, it is difficult for the user to grasp the setting content immediately after logon so that user convenience immediately after logon deteriorates. Further, since the operation content of before logging off needs to be stored for each user, there is a problem that a large amount of memory resources is required.

### SUMMARY

Aspects of the present invention are generally directed to suppressing deterioration in user convenience by dispensing with the work and effort involved in re-performing an operation, of suppressing deterioration in user convenience immediately after logging on, and preventing impersonation by another user, even when the user is temporarily away from an apparatus during the midst of an operation.

According to an aspect of the present invention, an image processing apparatus includes a detection unit configured to detect a human body, an authentication unit configured to authenticate a user, and a control unit configured to shift to a state in which the user authenticated by the authentication unit is logged on the image processing apparatus, and to receive an operation from an operation unit, wherein, in a logged-on state, if a detecting state of the detection unit has been changed from a detecting state to a non-detecting state, the control unit retains a state of the image processing apparatus and requests authentication by the authentication unit, and if a currently logged-on user is authenticated in response to the authentication request, the control unit returns the image processing apparatus to the retained state.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an image processing apparatus.

FIGS. 2A and 2B illustrate an example of a positional relationship between the image processing apparatus and a user, and a detection range of a human detection sensor unit.

FIG. 3 illustrates an example of a user interface section of an image processing apparatus.

FIGS. 4A, 4B, 4C, 4D, 4E, 4F, 4G, 4H, and 4I illustrate examples of a display screen in a display unit provided with a touch panel in the image processing apparatus.

FIG. 5A is a flowchart illustrating an example of a main routine operation of an image processing apparatus, and FIG. 5B is a flowchart illustrating an example of a setting processing operation of the image processing apparatus.

FIG. 6 is a flowchart illustrating an example of a human detection sensor non-detection interruption processing operation of the image processing apparatus.

### DESCRIPTION OF THE EMBODIMENTS

Hereinafter, various exemplary embodiments will be described in detail below with reference to the drawings.

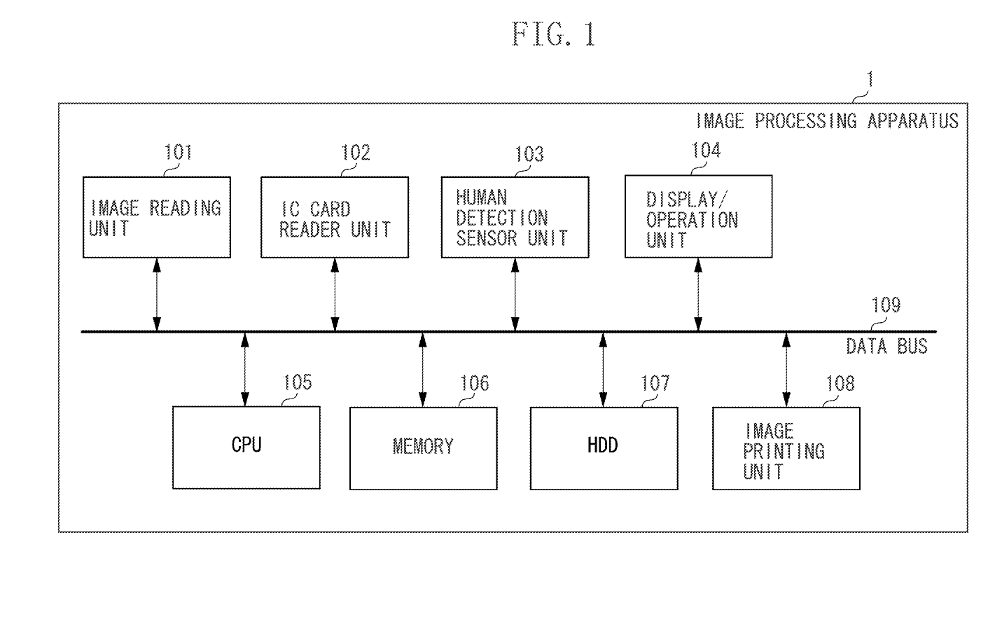

FIG. 1 is a block diagram illustrating an example of a configuration of an image processing apparatus according to an exemplary embodiment. In FIG. 1, an image processing apparatus 1 includes an image reading unit 101, an integrated chip (IC) card reader unit 102, a human detection sensor unit 103, a display/operation unit 104, a central processing unit (CPU) 105, a memory 106, a hard disk drive (HDD) 107, an image printing unit 108, and a data bus 109.

The image reading unit 101, which operates under the control of the CPU 105, generates image data by scanning a document set by a user on a non-illustrated platen, and transmits the generated image data to the memory 106 via the data bus 109. The IC card reader unit 102, which operates under the control of the CPU 105, stores data read from a non-contact IC card in the memory 106 via the data bus 109.

The human detection sensor unit 103 includes a sensor for detecting a user (a human body) around the image processing apparatus 1, and transmits information detected by the sensor to the CPU 105 under the control of the CPU 105. The human detection sensor unit 103 is connected to a non-illustrated power source unit. If the human detection sensor unit 103 detects a person around the image processing apparatus 1, the human detection sensor unit 103 shifts the image processing apparatus 1, which is in a power saving state, to a standby state. This power saving state is a state in which the power supply to the human detection sensor unit 103 is maintained, but the power supply to other devices is cut off. These other devices include the image reading unit 101, the IC card reader unit 102, the display/operation unit 104, the CPU 105, the memory 106, the HDD 107, the image printing unit 108, and the data bus 109.

During this power saving state, when the human detection sensor unit 103 detects a user around the image processing apparatus 1, the human detection sensor unit 103 transmits a wakeup control signal to the power source unit. The power source unit receives the wakeup control signal, starts to supply power to the other devices, and the image processing apparatus 1 enters a standby state. Consequently, the image processing apparatus 1 shifts to a usable state without the user having to do any special operation, by user just approaching the image processing apparatus 1. Further, the human detection sensor unit 103 can be set by the CPU 105 so as to transmit an interruption signal to the CPU 105 when the human detection sensor has changed from a detecting state to a non-detecting state.

The display/operation unit 104, which operates under the control of the CPU 105, displays information received via the data bus 109 from the CPU 105 on a below-described display unit 5 that is provided with a touch panel. Further, the display/operation unit 104 transmits to the CPU 105 operation information based on a user operation of the below-described display unit 5 provided with a touch panel and of a start button 6.

The CPU 105 reads a program stored in the HDD 107 into the memory 106, and controls the whole image processing apparatus 1 based on that program. When an interruption signal is received from the human detection sensor unit 103, the CPU 105 can shift control to a preset interruption routine. The memory 106 is a temporarily memory for storing programs of the CPU 105 and image data. The HDD 107, which is a hard disk drive, stores programs of the CPU 105 as well as image data. Other storage devices, such as a solid state drive (SS), may be provided instead of the HDD 107.

The image printing unit 108, which operates under the control of the CPU 105, prints and outputs image data received via the data bus 109 on non-illustrated printing paper using an arbitrary printing method, such as an electrophotographic process or an inkjet method. The data bus 109 transfers image data or information to and from each of the above-described devices 101 to 108.

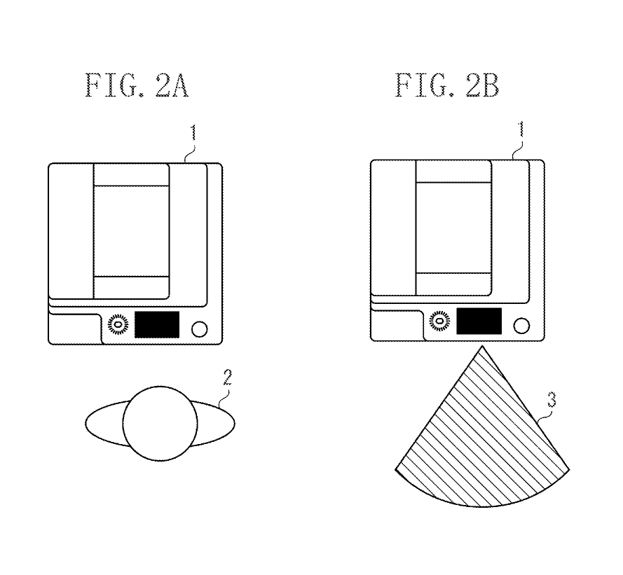

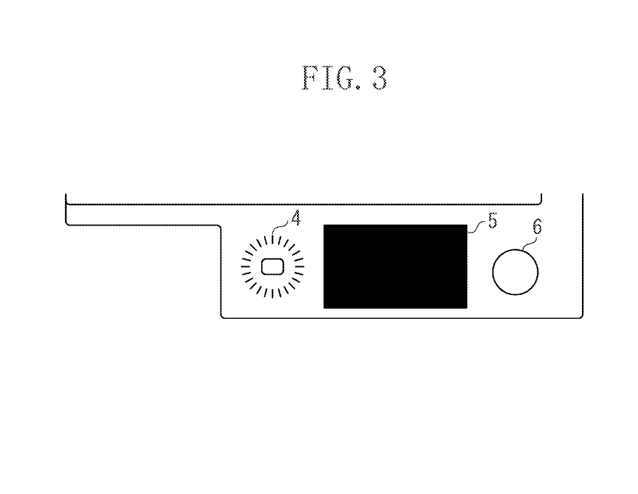

FIGS. 2A and 2B illustrate schematic diagrams illustrating an example of a positional relationship between the image processing apparatus 1 and the user, and a detection range of the human detection sensor unit 103 as seen from an overhead perspective looking down.

In FIG. 2A, a user 2 is at a position where he/she can operate the image processing apparatus 1.

FIG. 2B illustrates a detection range 3 of the human detection sensor unit 103, which is indicated by a hatched area to facilitate description, although cannot be actually seen. A sensor in the human detection sensor unit 103 can detect a user in this detection range 3. Namely, the detection range 3 can detect the user 2 who is at the position illustrated in FIG. 2A.

FIG. 3 is a schematic diagram illustrating an example of just a user interface section of the image processing apparatus 1.

The user interface section of the image processing apparatus 1 includes a card reader 4 of the IC card reader unit 102, a display unit 5 provided with a touch panel of the display/operation unit 104, and a start button 6.

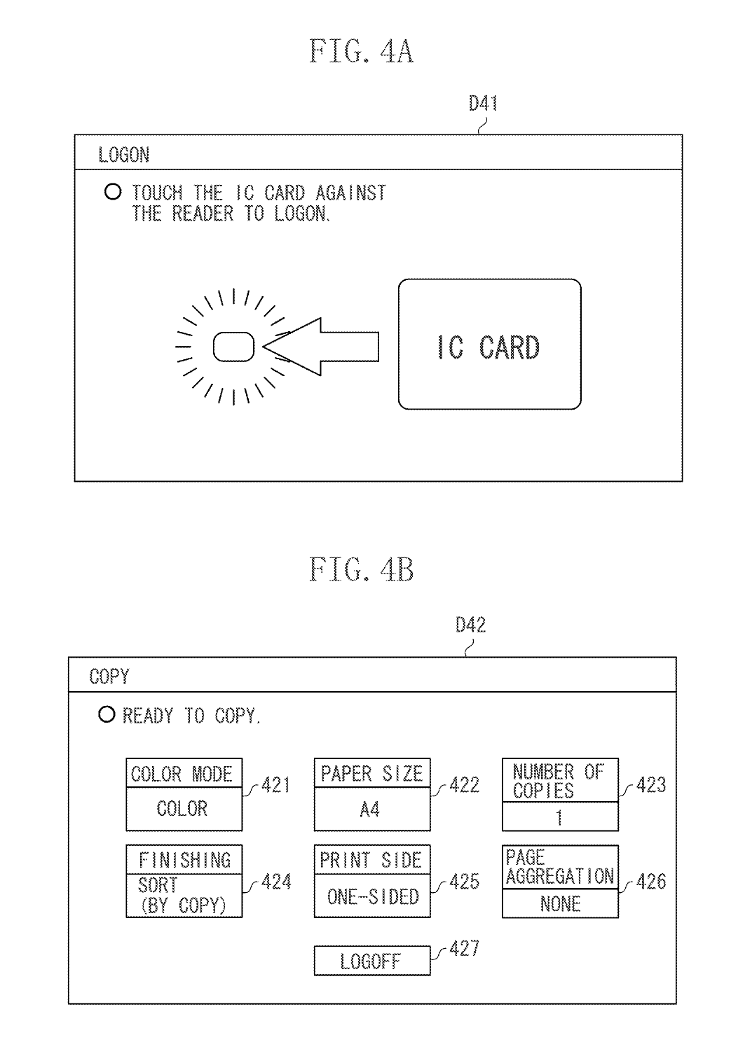

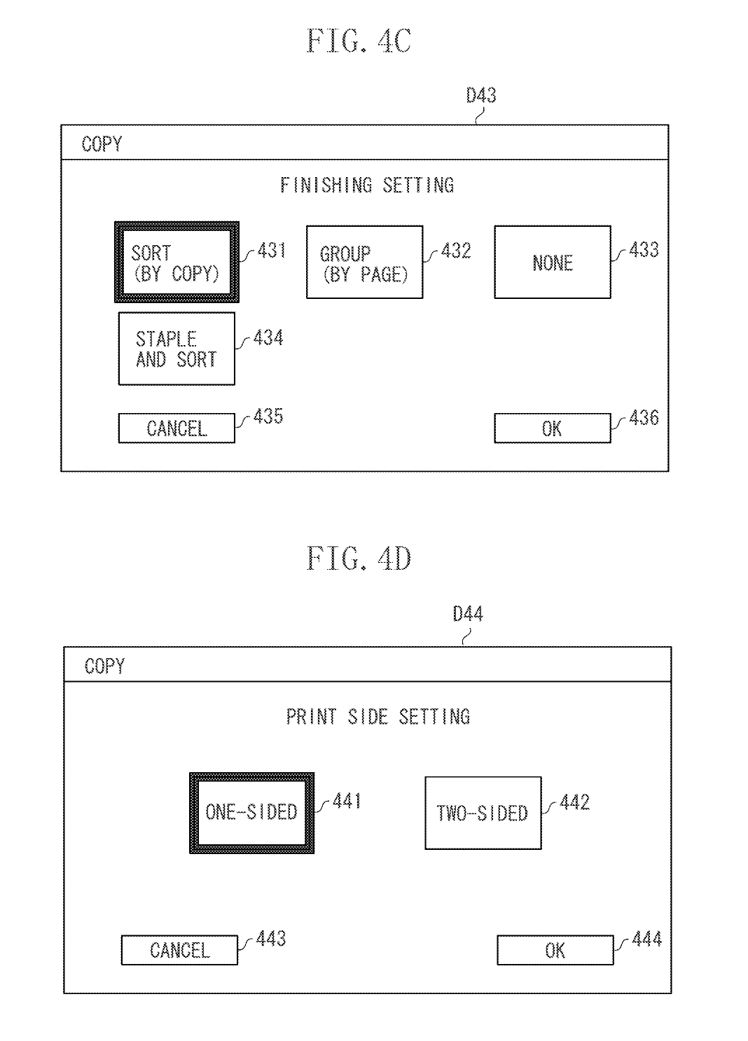

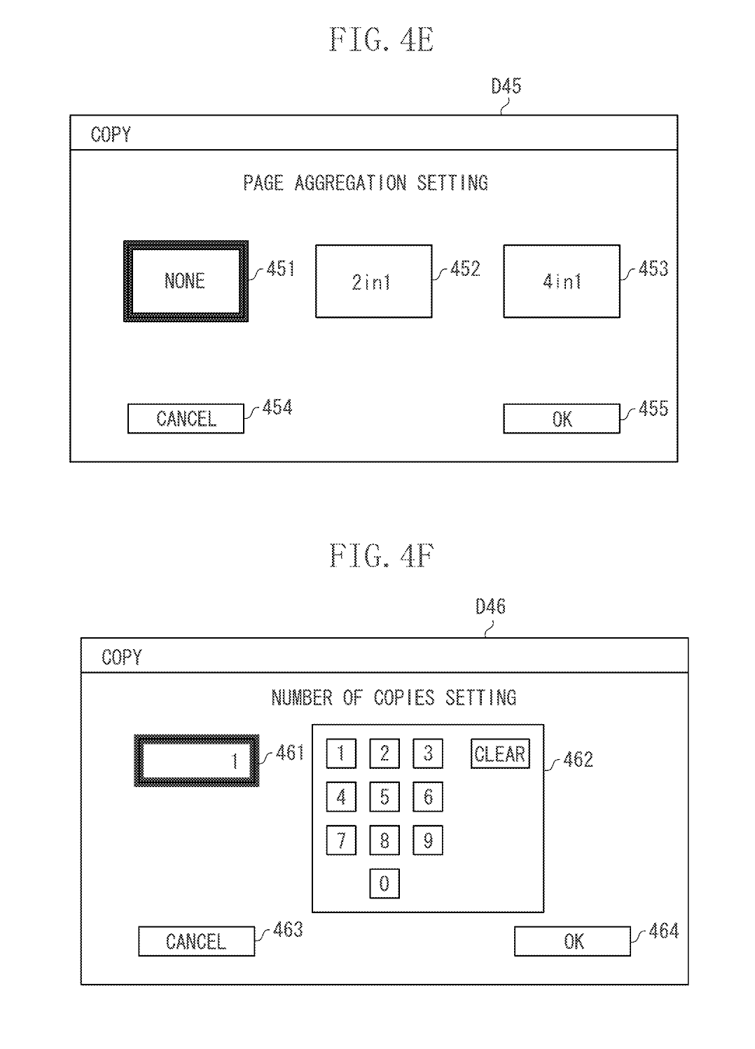

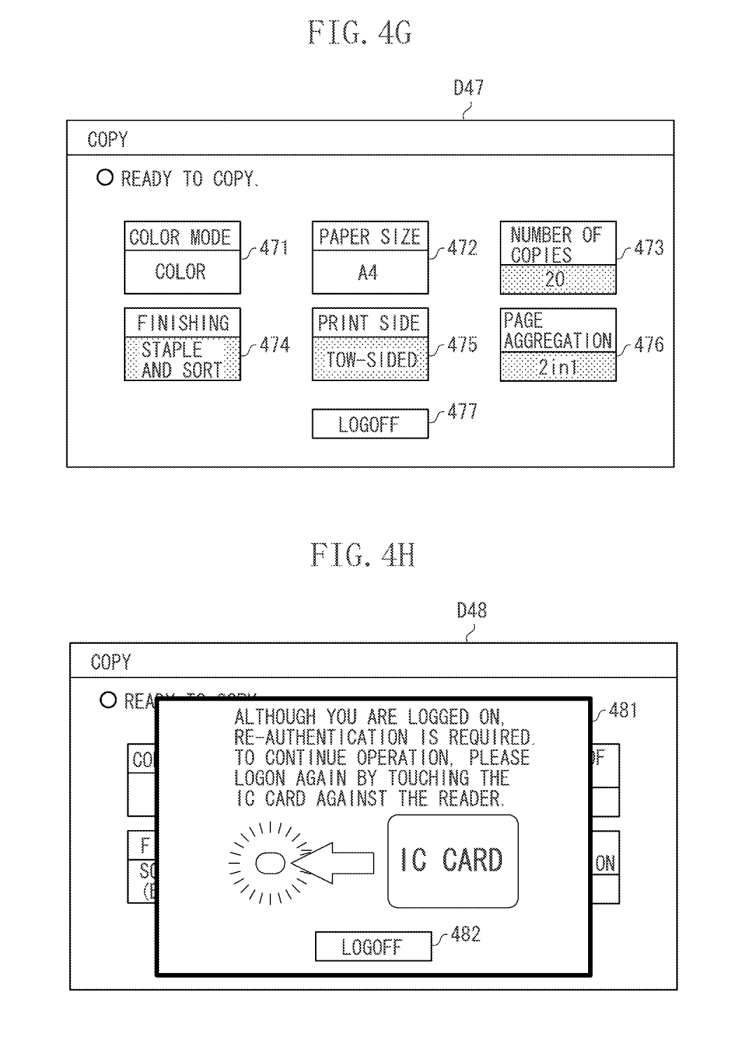

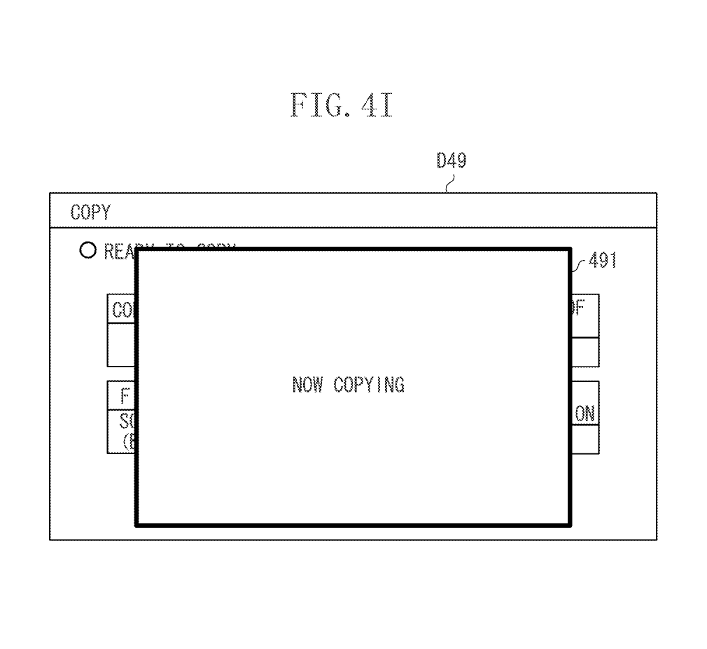

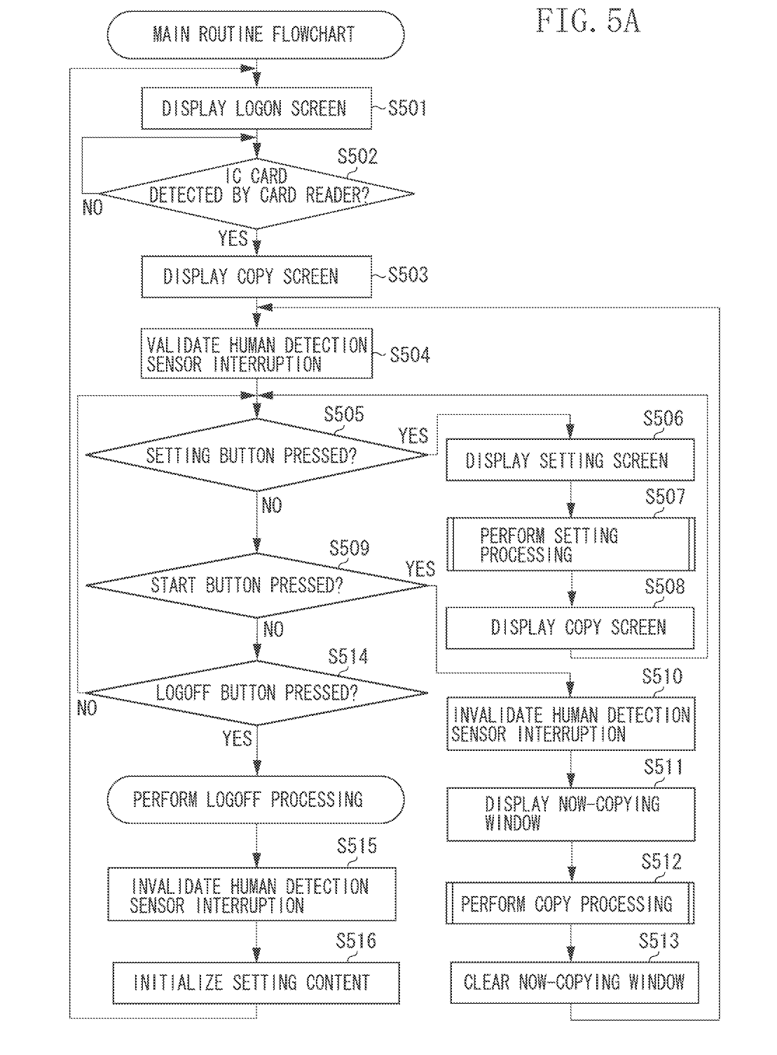

FIGS. 4A to 4I illustrate examples of a screen displayed on the display unit 5 provided with a touch panel in the image processing apparatus 1.

FIG. 4A illustrates a logon screen D41 when the user has not yet logged on to the image processing apparatus 1.

FIG. 4B illustrates a copy screen D42 that is transitioned to when the user logs on by making the card reader 4 read an IC card on the logon screen D41. The copy screen D42 includes a color mode setting button 421, a paper size setting button 422, a number of copies setting button 423, a finishing setting button 424, a print side setting button 425, and a page aggregation setting button 426. By touching these buttons, the user can display the individual setting screens on which the various settings for the image processing apparatus 1 are to be performed. Beneath each button, the current setting content is displayed. The user can reset all of the settings, log off from a logged-on state, and return the display screen of the image processing apparatus 1 to the logon screen D41 by touching a logoff button 427.

FIG. 4C illustrates a finishing setting screen D43 that is transitioned to when the user touches the finishing setting button 424 on the copy screen D42. The finishing setting screen D43 includes a sort setting button 431, a group setting button 432, a none (no setting) button 433, and a staple and sort setting button 434. These buttons are setting change buttons for changing a setting. By touching these buttons, the user can change the setting content of the finishing setting. The button indicating the current setting content is displayed in bold. When the user touches a different setting change button, the touched button is displayed in bold simultaneously with the setting change.

The finishing setting screen D43 also includes a cancel button 435 and an OK button 436. When the user touches the cancel button 435, the setting content returns to the setting content of before the transition to the finishing setting screen D43, and the screen transitions to the previous copy screen D42. When the user touches the OK button 436, the screen transitions to the previous copy screen D42. At this stage, the changed setting content is displayed beneath the finishing setting button 424. In addition, if that content is different from a default value after logon, the fact that the setting has been changed is indicated by hatching (e.g., 474 in the below-described FIG. 4G).

FIG. 4D illustrates a print side setting screen D44 that is transitioned to when the user touches the print side setting button 425 on the copy screen D42. The print side setting screen D44 includes a one-sided setting button 441 and a two-sided setting button 442. These buttons are setting change buttons for changing a setting. By touching these buttons, the user can change the setting content of the print side setting. The button indicating the current setting content is displayed in bold. When the user touches a different setting change button, the touched button is displayed in bold simultaneously with the setting change.

The print side setting screen D44 also includes a cancel button 443 and an OK button 444. When the user touches the cancel button 443, the setting content returns to the setting content of before the transition to the print side setting screen D44, and the screen transitions to the previous copy screen D42. When the user touches the OK button 444, the screen transitions to the previous copy screen D42. At this stage, the changed setting content is displayed beneath the print side setting button 425. In addition, if that content is different from the default value after logon, the fact that the setting has been changed is indicated by hatching (e.g., 475 in the below-described FIG. 4G).

FIG. 4E illustrates a page aggregation setting screen D45 that is transitioned to when the user touches the page aggregation setting button 426 on the copy screen D42. The page aggregation setting screen D45 includes a none (no setting) button 451, a 2-in-1 setting button 452, and a 4-in-1 setting button 453. These buttons are setting change buttons for changing a setting. By touching these buttons, the user can change the setting content of the page aggregation setting. The button indicating the current setting content is displayed in bold. When the user touches a different setting change button, the touched button is displayed in bold simultaneously with the setting change.

The page aggregation setting screen D45 also includes a cancel button 454 and an OK button 455. When the user touches the cancel button 454, the setting content returns to the setting content of before the transition to the page aggregation setting screen D45, and the screen transitions to the previous copy screen D42. When the user touches the OK button 455, the screen transitions to the previous copy screen D42. At this stage, the changed setting content is displayed beneath the page aggregation setting button 426. In addition, if that content is different from the default value after logon, the fact that the setting has been changed is indicated by hatching (e.g., 476 in the below-described FIG. 4G).

FIG. 4F illustrates a number of copies setting screen D46 that is transitioned to when the user touches the number of copies setting button 423 on the copy screen D42. The number of copies setting screen D46 includes a number of copies setting value indicator 461 and number of copies setting buttons 462. The number of copies setting buttons 462 are a collection of numeric buttons and a clear button. These buttons are setting change buttons for changing a setting. By touching these buttons, the user can change the setting content of the number of copies setting. The current setting content is displayed on the number of copies setting value indicator 461. When the user touches the number of copies setting buttons 462, the new setting value is simultaneously displayed on the number of copies setting value indicator 461.

The number of copies setting screen D46 also includes a cancel button 463 and an OK button 464. When the user touches the cancel button 463, the setting content returns to the setting content of before the transition to the number of copies setting screen D46, and the screen transitions to the previous copy screen D42. When the user touches the OK button 464, the screen transitions to the previous copy screen D42. At this stage, the changed setting content is displayed beneath the number of copies setting button 423. In addition, if that content is different from the initial value after logon, the fact that the setting has been changed is indicated by hatching (e.g., 473 in the below-described FIG. 4G).

FIG. 4G illustrates a copy screen D47 on which a setting has changed. The example of FIG. 4G illustrates a state in which, from the state of the copy screen D42 immediately after logon, “staple and sort” was selected on the finishing setting screen D43, “two-sided” was selected on the print side setting screen D44, “2-in-1” was selected on the page aggregation setting screen D45, and “20 copies” was selected on the number of copies setting screen D46.

FIG. 4H illustrates a re-authentication screen D48 that is displayed when, in the state of the copy screen D47, the user moved out of the detection range 3 of the human detection sensor unit 103. The re-authentication screen D48 is for prompting the user to perform re-authentication. The re-authentication screen D48 includes a re-authentication window 481 and a logoff button 482. When the re-authentication screen D48 is displayed, the user can only perform an authentication operation by making the card reader 4 read the IC card, or log off by touching the logoff button 482. In other words, while the re-authentication screen D48 is displayed, only authentication or logging off can be performed. Other operations are prohibited. This prevents another user who does not have an IC card from continuing to perform operations instead of the original user. If an authentication operation is performed on this screen by making the card reader 4 read the IC card, the re-authentication window 481 is cleared, and the previous screen (in this case, the previous copy screen D47) is displayed.

FIG. 4I illustrates a now-copying screen D49 displayed when the user pressed the start button 6 in the state of the copy screen D47. The now-copying screen D49 includes a now-copying window 491. While the now-copying screen D49 is displayed, the user cannot perform any operations. When the copying operation has finished, the copying window 491 is cleared, and the screen returns to the copy screen D47.

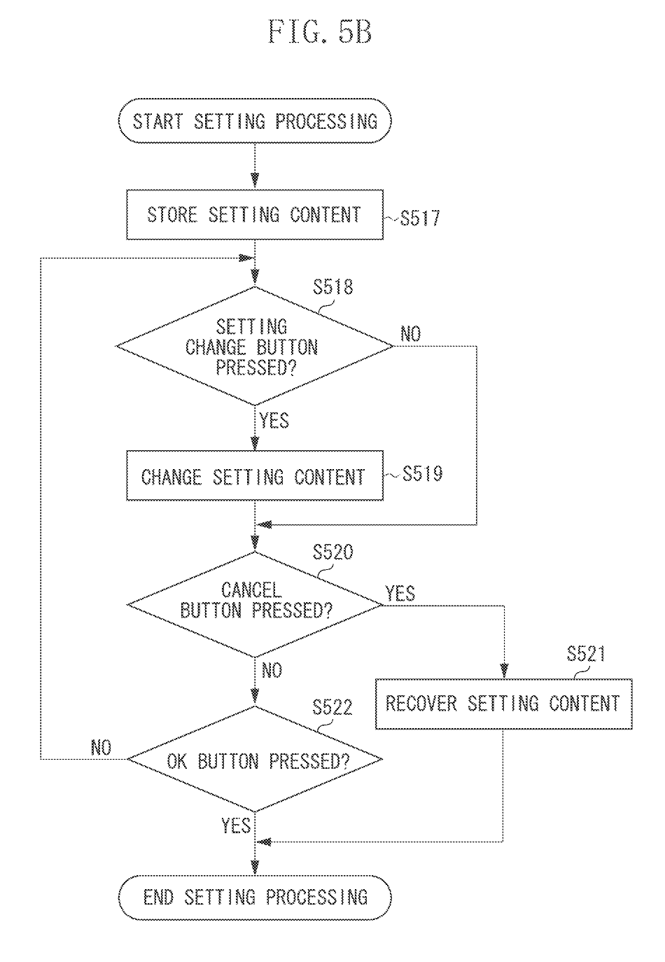

FIGS. 5A and 5B are flowcharts illustrating an example of operations by the image processing apparatus 1 under the control of the CPU 105. The processing in the flowcharts illustrated in FIGS. 5A and 5B is realized by the CPU 105 reading and executing a program recorded in the HDD 107 in a manner that allows it to be read by a computer. S501 to S522 represent the respective steps.

FIG. 5A is a flowchart illustrating a main routine operation. The CPU 105 in the image processing apparatus 1 starts the processing from step S501.

In step S501, the CPU 105 displays the logon screen D41 on the display unit 5 provided with a touch panel, and the processing then proceeds to step S502. In step S502, the CPU 105 performs monitoring until an IC card is detected by the IC card reader unit 102. If it is determined that an IC card has been detected (YES in step S502), the processing proceeds to step S503. Although not illustrated, the processing proceeds to step S503 because the image processing apparatus 1 shifts to a logged-on state by an authenticated user and receives operations from the display/operation unit only when user authentication is successful. On the other hand, if user authentication fails, the processing returns to step S502.

In step S503, the CPU 105 displays the copy screen D42 on the display unit 5 provided with a touch panel, and the processing then proceeds to step S504. In step S504, the CPU 105 sets the human detection sensor unit 103 so that an interruption signal is transmitted to the CPU 105 when the human detection sensor has changed from a detecting state to a non-detecting state, and the processing proceeds to step S505.

In step S505, the CPU 105 determines whether a setting button touch has been detected by the display unit 5 provided with a touch panel. If it is determined that a setting button touch has been detected (YES in step S505), the processing proceeds to step S506. On the other hand, if it is determined that a setting button touch has not been detected (NO in step S505), the processing proceeds to step S509. Examples of this setting button include the color mode setting button 421, the paper size setting button 422, the number of copies setting button 423, the finishing setting button 424, the print side setting button 425, and the page aggregation setting button 426 on the copy screen D42.

In step S506, the CPU 105 displays a setting screen on the display unit 5 provided with a touch panel, and the processing then proceeds to step S507. The setting screen to be displayed is different based on the kind of setting button for which the touch was detected in step S505. If the setting button for which the touch was detected is the color mode setting button 421, the displayed setting screen is a non-illustrated color mode setting screen. If the setting button for which the touch was detected is the paper size setting button 422, the displayed setting screen is a non-illustrated paper size setting screen. If the setting button for which the touch was detected is the number of copies setting button 423, the displayed setting screen is the number of copies setting screen D46. If the setting button for which the touch was detected is the finishing setting button 424, the displayed setting screen is the finishing setting screen D43. If the setting button for which the touch was detected is the print side setting button 425, the displayed setting screen is the print side setting screen D44. If the setting button for which the touch was detected is the page aggregation setting button 426, the displayed setting screen is the page aggregation setting screen D45.

In step S507, the CPU 105 executes setting processing. The setting processing of step S507 is processing in which the CPU 105 rewrites the setting content stored in the memory 106 based on the user operation. Such setting processing will be described in more detail with reference to FIG. 5B. After the CPU 105 has executed the setting processing of step S507, the processing proceeds to step S508.

In step S508, the CPU 105 displays a copy screen on the display unit 5 provided with a touch panel, and the processing returns to step S505. As described above, on the copy screen, the letters and hatching of the setting content that are beneath the setting button are different depending on the setting content (e.g., D47 in FIG. 4G).

In step S509, the CPU 105 determines whether pressing of the start button has been detected. If it is determined that pressing of the start button has been detected (YES in step S509), the processing proceeds to step S510. On the other hand, if it is determined that pressing of the start button has not been detected (NO in step S509), the processing proceeds to step S514.

In step S510, the CPU 105 sets the human detection sensor unit 103 so that an interruption signal is not transmitted to the CPU 105 when the human detection sensor has changed from a detecting state to a non-detecting state, and the processing then proceeds to step S511. In step S511, the CPU 105 displays the now-copying window 491 on the display unit 5 provided with a touch panel, and the processing then proceeds to step S512.

In step S512, the CPU 105 performs copy processing by making the image reading unit 101, the memory 106, the HDD 107, and the image printing unit 108 operate in a coordinated manner based on the setting content stored in the memory 106, and the processing then proceeds to step S513. A detailed description of the copy processing will be omitted. Then, in step S513, the CPU 105 clears the now-copying window 491 that is displayed on the display unit 5 provided with a touch panel, and the processing then returns to step S504.

In step S514, the CPU 105 determines whether a touch of the logoff button 427 (indicated by 477 on screen D47) has been detected. If it is determined that a touch of the logoff button 427 (477) has been detected (YES in step S514), the processing proceeds to logoff processing (steps S515 to S516). On the other hand, if it is determined that a touch of the logoff button 427 (477) has not been detected (NO in step S514), the processing returns to step S505.

In step S515 of the logoff processing, the CPU 105 sets the human detection sensor unit 103 so that an interruption signal is not transmitted to the CPU 105 when the human detection sensor has changed from a detecting state to a non-detecting state, and the processing then proceeds to step S516. In step S516, the CPU 105 returns the setting content stored in the memory 106 for all settings to the initial values, and the processing returns to step S501.

FIG. 5B is a flowchart illustrating an example of the setting processing of step S507 in FIG. 5A. The CPU 105 in the image processing apparatus 1 executes the processing of step S507 in FIG. 5A.

In step S517, the CPU 105 copies and stores the setting content stored in the memory 106 for all of the settings to a separate area of the memory 106, and the processing then proceeds to step S518.

In step S518, the CPU 105 determines whether a touch of a setting change button has been detected. If a touch of a setting change button has been detected (YES in step S518), the processing proceeds to step S519. On the other hand, if a touch of a setting change button has not been detected (NO in step S518), the processing proceeds to step S520. This setting change button is a setting change button displayed on the above-described setting screens. For example, for screen D43 in FIG. 4C, this button is one of the buttons 431 to 434, for screen D44 in FIG. 4D, this button is the button 441 or 442, for screen D45 in FIG. 4D, this button is one of the buttons 451 to 453, and for screen D46 in FIG. 4F, this button is the button 462.

In step S519, the CPU 105 changes the setting content stored in the memory 106 based on the setting change button that was touched, and the processing then proceeds to step S520. In step S520, the CPU 105 determines whether a touch of the cancel button has been detected. If it is determined that a touch of the cancel button has been detected (YES in step S520), the processing proceeds to step S521. On the other hand, if it is determined that a touch of the cancel button has not been detected (NO in step S520), the processing proceeds to step S522. This cancel button is a cancel button displayed on the above-described setting screens. For example, for screen D43, this button is the button 435, for screen D44, this button is the button 443, for screen D45, this button is the button 454, and for screen D46, this button is the button 463.

In step S521, the CPU 105 restores the setting content to the state before the change by reading the setting content copied to the separate area of the memory 106 in the above-described step S517 and overwriting with the setting content stored in the memory 106. The CPU 105 then finishes the setting processing, and the processing proceeds to step S508 in FIG. 5A.

In step S522, the CPU 105 determines whether a touch of the OK button has been detected. If it is determined that a touch of the OK button has been detected (YES in step S522), the CPU 105 finishes the setting processing, and the processing proceeds to step S508 in FIG. 5A. On the other hand, if it is determined that a touch of the OK button has not been detected (NO in step S522), the processing returns to step S518. This OK button is an OK button displayed on the above-described setting screens. For example, for screen D43, this button is the button 436, for screen D44, this button is the button 444, for screen D45, this button is the button 455, and for screen D46, this button is the button 464.

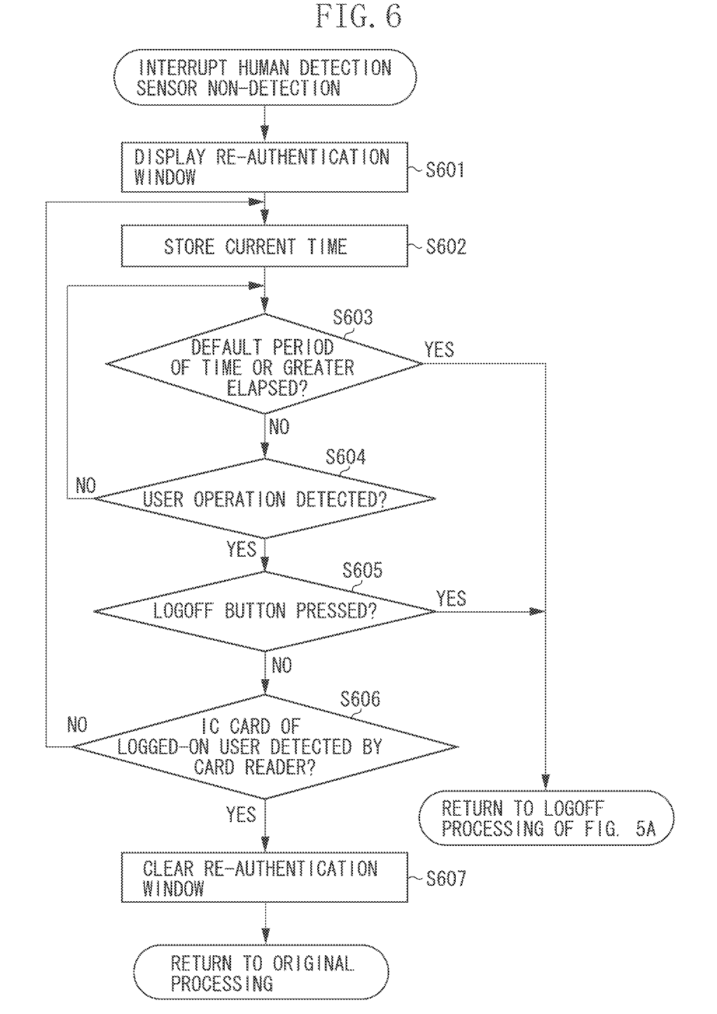

FIG. 6 is a flowchart illustrating operations performed under the control of the CPU 105 in the image processing apparatus 1, when the CPU 105 receives an interruption signal from the human detection sensor unit 103. The processing performed in the flowchart illustrated in FIG. 6 is realized by the CPU 105 reading and executing a program recorded in the HDD 107 in a manner that allows it to be read by a computer. S601 to S607 represent the respective steps.

When the CPU 105 in the image processing apparatus 1 receives an interruption signal from the human detection sensor unit 103, the CPU 105 stops the current processing, stores the step currently being processed in the memory 106, and executes human detection sensor non-detection interruption processing of FIG. 6 while retaining the state of the image processing apparatus 1 as is. The interruption signal is a signal that is transmitted from the human detection sensor unit 103 to the CPU 105 for just a duration that was preset by the CPU 105 in the human detection sensor unit 103 so that an interruption signal is transmitted. However, during the human detection sensor non-detection interruption processing illustrated in FIG. 6, the CPU 105 ignores received interruption signals.

First, in step S601, the CPU 105 displays the re-authentication window 481 of FIG. 4H on the display unit 5 provided with a touch panel, and the processing then proceeds to step S602. During the period that authentication is being requested by the display of the re-authentication window 481, the CPU 105 prohibits operations other than this authentication and the issuance of a logoff instruction.

In step S602, the CPU 105 receives the current time from a non-illustrated real time clock connected to the data bus 109, and stores the received current time in the memory 106.

Next, in step S603, the CPU 105 receives the current time from the non-illustrated real time clock, and calculates an elapsed period of time using this received time and the time stored in the memory 106 in step S602. For example, the CPU 105 calculates the elapsed period of time by subtracting the time stored in the memory 106 in step S602 from the current time received from the real time clock. Further, the CPU 105 determines whether the calculated elapsed period of time is equal to or greater than a default period of time (predetermined period of time). If it is determined that the calculated time equal to or greater than the default period of time (YES in step S603), the CPU 105 finishes the human detection sensor non-detection interruption processing, and the processing returns to the logoff processing (steps S515 to S516) illustrated in FIG. 5A. In this case, the CPU 105 discards the state that was retained when the interruption signal was received, and initializes the setting content of the image processing apparatus 1.

On the other hand, if it is determined that the elapsed period of time is less than the default period of time (NO in step S603), the processing proceeds to step S604.

In step S604, the CPU 105 determines whether a user operation has been detected. If it is determined that a user operation has been detected (YES in step S604), the processing proceeds to step S605. On the other hand, if it is determined that a user operation has not been detected (NO in step S604), the processing returns to step S603. Examples of this user operation include an input on the touch panel of the display unit 5 provided with a touch panel, or IC card detection by the IC card reader unit 102.

In step S605, the CPU 105 determines whether a touch of the logoff button 482 has been detected. If it is determined that a touch of the logoff button 482 has been detected (YES in step S605), the CPU 105 finishes the human detection sensor non-detection interruption processing, and the processing returns to the logoff processing (steps S515 to S516) illustrated in FIG. 5A. In this case, the CPU 105 discards the state that was retained when the interruption signal was received, and initializes the setting content of the image processing apparatus 1.

On the other hand, if it is determined that a touch of the logoff button 482 has not been detected (NO in step S605), the processing proceeds to step S606.

In step S606, the CPU 105 determines whether the IC card of the logged-on user has been detected by the IC card reader unit 102. If it is determined that the IC card of the logged-on user has been detected (YES in step S606), the processing proceeds to step S607. On the other hand, if it is determined that the IC card of the logged-on user has not been detected (NO in step S606), the processing returns to step S602. Further, the processing may also be configured so that if it is determined that the IC card of the logged-on user has not been detected (NO in step S606), the processing returns to step S603.

In step S607, the CPU 105 clears the re-authentication window 481 displayed on the display unit 5 provided with a touch panel, reads the step in the midst of being processed that was stored in the memory 106 when the interruption signal was received, returns to that step, and restarts the stopped processing. Namely, the CPU 105 returns the image processing apparatus 1 to the state that was retained when the interruption signal was received.

The procedure when the user performs copying using the image processing apparatus 1 will now be described based on the above configuration. The need for re-authentication when the user moves away from the image processing apparatus 1 during an operation, and the fact that the operation can be continued with content set before moving away from the image processing apparatus 1 if the user is again authenticated, will be described. Although the actions performed by the user will be mainly described in order to explain this series of operations, as described above, the image processing apparatus 1 operates under the control of the CPU 105.

First, as illustrated in FIG. 2A, the user stands in front of the image processing apparatus 1. The user is within the detection range of the human detection sensor of the human detection sensor unit 103. At this stage, the user places a non-illustrated copy document on a non-illustrated feeder unit of the image reading unit 101. At this point, since the logon screen D41 illustrated in FIG. 4A is displayed on the display unit 5 provided with a touch panel, when the user touches the IC card against the card reader 4, the copy screen D42 illustrated in FIG. 4B is displayed on the display unit 5 provided with a touch panel.

If the user touches the finishing setting button 424, the finishing setting screen D43 illustrated in FIG. 4C is displayed on the display unit 5 provided with a touch panel. If the user touches the staple and sort setting button 434 and then the OK button 436 on this screen, the display unit 5 provided with a touch panel returns to the copy screen.

Further, if the user touches the print side setting button 425, the print side setting screen D44 illustrated in FIG. 4D is displayed on the display unit 5 provided with a touch panel. If the user touches the two-sided setting button 442 and then the OK button 444 on this screen, the display unit 5 provided with a touch panel returns to the copy screen.

In addition, if the user touches the page aggregation setting button 426, the page aggregation setting screen D45 illustrated in FIG. 4E is displayed on the display unit 5 provided with a touch panel. If the user touches the 2-in-1 setting button 452 and then the OK button 455 on this screen, the display unit 5 provided with a touch panel returns to the copy screen.

Still further, if the user touches the number of copies setting button 423, the number of copies setting screen D46 illustrated in FIG. 4F is displayed on the display unit 5 provided with a touch panel. If the user inputs 20 with the numeric buttons of the number of copies setting buttons 462, the display unit 5 provided with a touch panel returns to the copy screen. Based on the settings until this point, the screen displayed on the display unit 5 provided with a touch panel looks like the copy screen D47 illustrated in FIG. 4G. As described above, this setting content is stored in the memory 106.

Next, if the user moves away from in front of the image processing apparatus 1 and leaves the detection range of the human detection sensor of the human detection sensor unit 103, the re-authentication screen D48 illustrated in FIG. 4H is displayed on the display unit 5 provided with a touch panel. As described above, this is due to the CPU 105 proceeding to the processing from step S601 of FIG. 6 based on an interruption signal transmitted from the human detection sensor unit 103. At this stage too, the setting content is as stored in the memory 106.

Then, as illustrated in FIG. 2A, if the user returns to in front of the image processing apparatus 1, confirms the re-authentication screen D48 displayed on the display unit 5, and touches the IC card against the card reader 4, the copy screen D47 illustrated in FIG. 4G is displayed on the display unit 5. Since the setting content of the display content at this point is the same as before the re-authentication screen D48 was displayed, the user does not have to perform a re-setting or a screen transition operation again.

Then, in a state in which the copy screen D47 illustrated in FIG. 4G is displayed, if the user presses the start button, the now-copying screen D49 illustrated in FIG. 4I is displayed on the display unit 5 provided with a touch panel, and a copy operation is performed. Based on this copy operation, a copy output is discharged onto a non-illustrated discharge tray unit of the image printing unit 108. Then, after the copy operation has finished, the copy screen D47 illustrated in FIG. 4G is displayed on the display unit 5 provided with a touch panel. The user takes the copy document from the non-illustrated feeder unit of the image reading unit 101, and the copy output from the non-illustrated discharge tray unit of the image printing unit 108.

Then, if the user touches the logoff button 477, the logoff processing is performed, and the logon screen D41 illustrated in FIG. 4A is displayed on the display unit 5 provided with a touch panel. As described above, in the logoff processing, since the CPU 105 initializes the setting content in step S516 of FIG. 5A, when the user logs on again, the setting content is returned to the initial values, and the copy screen D42 illustrated in FIG. 4B is always displayed as the copy screen after logging on.

Further, in a state in which the re-authentication screen D48 is displayed, if the user does not perform re-authentication within a predetermined duration, the logoff processing is performed under the control of the CPU 105 in the above-described step S603 of FIG. 6. In addition, in a state in which the re-authentication screen D48 is displayed, if the user or another user touches the logoff button 482, the logoff processing is performed under the control of the CPU 105 in the above-described step S605 of FIG. 6. Namely, although the logoff processing can be performed even in a state in which re-authentication is required, the operation to be performed in a state in which the original user is logged on cannot be performed unless re-authentication is performed. Further, the image processing apparatus 1 can also be configured so that while the re-authentication screen D48 is displayed, only authentication is possible, and operations other than authentication are prohibited.

Thus, according to the image processing apparatus according to the present exemplary embodiment, a situation in which another person pretends to be the user when the user is away from the apparatus can be prevented without reducing user convenience in the midst of an operation and even immediately after logging on.

In the example of FIG. 6, the processing is configured to return to step S602 or S603 if the IC card of a user other than the currently logged-on user is detected during the period that the authentication request is displayed on the re-authentication screen D48. However, the processing may also be configured so that if the IC card of a user other than the currently logged-on user is detected during the period that the authentication request is displayed on the re-authentication screen D48, and authentication is successful, the CPU 105 logs off the currently logged-on user, and shifts to a state in which the authenticated new user is logged on. In this case, since the previous user is logged off and a new user logged on, the state of the apparatus retained when the interruption signal was received is discarded, and an initial screen for the new user is displayed.

In the above-described exemplary embodiment, a configuration was illustrated in which user authentication was performed by reading information from a non-contact IC card. However, a card used to authenticate a user may be a contact IC card or a card having some other formats such as a magnetic card. Further, a configuration may be employed that enables input of authentication information, such as a user ID and a password, from the display/operation unit 104 to be received, and user authentication is performed using authentication information input from a user. Furthermore, a configuration may also be employed in which biometric authentication information from a user is read, and user authentication is performed using this biometric authentication information. Examples of biometric authentication information include information about fingerprints, palm shape, a retinal capillary pattern, an iris pattern, the face, a hand vein pattern, the voice, ear geometry and the like.

As described above, deterioration in user convenience can be suppressed by dispensing with the work and effort involved in re-performing an operation, and that can prevent impersonation by another user even when a user is temporarily away from an apparatus during the midst of an operation without reducing user convenience immediately after logging on. Accordingly, a high level of security can be maintained without sacrificing user convenience.

The structure and content of the above-described various kinds of data are not limited to the above examples. Obviously, various structures and content can be employed based on the application and intended purpose.

Although an exemplary embodiment was illustrated above, it is not considered to be limiting, and additional embodiments, for example, a system, an apparatus, a method, a program, a storage medium or the like, are applicable. Specifically, a system configured from a plurality of devices, or in a system configured from a single device are applicable. Further, all configurations obtained by combining the above-described various exemplary embodiments are also applicable.

According to the above-described exemplary embodiment(s), deterioration in user convenience can be suppressed by dispensing with the work and effort involved in re-performing an operation, and that can prevent impersonation by another user even when a user is temporarily away from an apparatus during the midst of an operation without reducing user convenience immediately after logging on. Therefore, a high level of security can be maintained without sacrificing user convenience.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-130197 filed Jun. 21, 2013, which is hereby incorporated by reference herein in its entirety.

What is claimed is:

1. An image processing apparatus comprising:
a detection unit configured to detect a human body;
an authentication unit configured to authenticate a user; and
a control unit configured to shift to a state in which the user authenticated by the authentication unit is logged on the image processing apparatus, and to receive an operation from an operation unit,
wherein, in a logged-on state, if a detecting state of the detection unit has been changed from a detecting state to a non-detecting state, the control unit retains a state of the image processing apparatus and requests authentication by the authentication unit, and if a currently logged-on user is authenticated in response to the authentication request, the control unit returns the image processing apparatus to the retained state.

2. The image processing apparatus according to claim 1, wherein the control unit can receive a logoff instruction from the operation unit during the authentication request, and
wherein, if the logoff instruction is received, the control unit logs off and discards the retained state.

3. The image processing apparatus according to claim 1, wherein the control unit logs off and discards the retained state if the requested authentication has not been performed even though a predetermined period of time has elapsed since the authentication request was made.

4. The image processing apparatus according to claim 1, wherein, if a user other than the currently logged-on user is authenticated during the authentication request, the control unit logs off, discards the retained state, and shifts to a state in which the authenticated user is logged on.

5. The image processing apparatus according to claim 1, wherein the control unit displays on a display unit a screen prompting re-authentication during the authentication request.

6. The image processing apparatus according to claim 1, wherein the authentication unit performs user authentication by using information read from an IC card or a magnetic card.

7. The image processing apparatus according to claim 1, wherein the authentication unit performs user authentication by using information input from the operation unit.

8. The image processing apparatus according to claim 1, wherein the authentication unit performs user authentication by reading biometric authentication information about the user.

9. A method for controlling an image processing apparatus, the method comprising:
detecting a human body;
authenticating a user;
shifting to a state in which the authenticated user is logged onto the image processing apparatus; and
receiving an operation,
wherein, in a logged-on state, if a state of detecting a human body been changed from a detecting state to a non-detecting state, a state of the image processing apparatus is retained and authentication is requested, and
wherein the image processing apparatus is returned to the retained state if a currently logged-on user is authenticated in response to the authentication request.

10. A computer-readable storage medium storing computer executable instructions for causing a computer to execute a method, the method comprising:
detecting a human body;
authenticating a user;
shifting to a state in which the authenticated user is logged onto the image processing apparatus; and
receiving an operation,
wherein, in a logged-on state, if a state of detecting a human body been changed from a detecting state to a non-detecting state, a state of the image processing apparatus is held and authentication is requested, and
wherein the image processing apparatus is returned to the retained state if a currently logged-on user is authenticated in response to the authentication request.
